(19) United States
(12) Patent Application Publication
(10) Pub. No.: US 2004/0105635 A1
(43) Pub. Date: Jun. 3, 2004

(54) Fiber optic transmission conductor and distributed temperature sensing of fiber optic transmission conductor

(76) Inventors: Shantanu Nandi, Oak Park, IL (US); James Patrick Crane, Wheaton, IL (US)

Correspondence Address: SMITH, GAMBRELL & RUSSELL, LLP, 1850 M STREET, N.W., SUITE 800, WASHINGTON, DC, 20036, US

(21) Appl. No.: 10/622,191

(22) Filed: Jul. 18, 2003

Related U.S. Application Data
(60) Provisional application No. 60/396,788, filed on Jul. 18, 2002.

(51) Int. Cl. G02B 6/44

(52) U.S. Cl. 385/101

(57) ABSTRACT

A conductive cable having an optic fiber arranged longitudinally along the cable. The optic fiber can be used as a dynamic temperature sensor that provides real time data regarding the temperature of the cable. This data can be used so to increase the efficient use of the conductive cable. Furthermore, this data can be used to determine whether the proper size of cable is being used or to select new cables for existing circuits.

### CROSS-REFERENCE TO RELATED APPLICATIONS

This application claims priority to provisional patent application Serial No. 60/396,788, which is relied on and incorporated herein by reference.

### BACKGROUND OF THE INVENTION

The present invention relates to a method for sensing the temperature of a conductive cable called a fiber optic transmission conductor, which is a new type of bare transmission conductor cable having at least one embedded fiber optic member located longitudinally along the cable.

Electric utility companies depend upon high voltage transmission systems to deliver power from generating plants to customer loads. Due to its high mechanical strength-to-weight ratio and good current carrying capacity, the most commonly used conductor material for these lines is aluminum conductor, steel reinforced referred to as “ACSR”. ACSR consists of a solid or stranded galvanized steel core surrounded by one or more layers of aluminum strands.

The amount of electrical current that a transmission conductor cable can carry is limited by temperature. As electrical current passes through a conductor, heat is generated. Without external influences such as wind, rain, solar radiation, and ever changing ambient air temperatures, it is relatively simple to determine the temperature of a known conductor cable with a given electrical current flow in a steady state ambient air temperature. In contrast, it is extremely difficult to determine the temperature of a conductor under real world operating conditions. Under normal operating conditions, large changes in the amount of electrical current flowing in the conductor, ambient air temperature, wind and solar radiation are experienced by the conductor each day. Even with accurate measurement of all of these variables, it is very difficult to calculate the temperature of a conductor at all points along a conductor that may be several miles long.

Conventional methods for measuring cable/conductor temperatures include Valley Group CAT-1 Tension Monitor, the EPRI Video Sagometer, and the USI donut. The CAT-1 method measures cable tension and weather conditions and the calculates the expected cable temperature using a thermal model. The EPRI Video Sagometer measures the cable sag and then calculates the expected cable temperature using a thermal elongation model. The USI donut uses two thermocouples placed on the outside surface of the transmission cable to measure its temperature at a single point. None of these methods measure the internal temperature of the cable/conductor or give real time temperature data for the length of the cable. Furthermore, they fail to satisfactorily measure cable temperature axially and radially throughout the entire length of the cable.

The aforementioned conventional methods do not rely on the use of a fiber optic distributed temperature sensor, however, there are U.S. patents that describe temperature sensing with a fiber optics. The following U.S. patents describe temperature sensing with fiber optics and/or detail cables having optic fibers and electrical conductors.

U.S. Pat. No. 5,696,863 details fiber optic methods and devices for sensing physical parameters, like temperature or force.

U.S. Pat. No. 5,991,479 details distributed fiber optic sensors to measure temperature at different points along the fiber.

U.S. Pat. No. 4,852,965 details a composite optical fiber-copper conductor, which includes one or more reinforced optical fiber units and one or more metallic conductor pairs enclosed in a sheath system.

U.S. Pat. No. 4,952,020 details a ribbon cable having optical fibers and electrical conductors spaced side to side within a flexible jacket.,

U.S. Pat. No. 5,029,974 details a gel-filled plastic buffer tube for carrying optical fibers.

U.S. Pat. No. 5,651,081 details a composite fiber optic and electrical cable having a core which loosely contains at least one optical fiber, one or more electrical conductors having an outer polymer insulating layer, one or more strength members, and a surrounding protective jacket.

U.S. Pat. Nos. 5,917,977 and 6,049,647 detail a composite cable having a conductor and at least one fiber optic conductor in the core.

U.S. Pat. No. 6,072,928 relates to a tow cable for measuring temperature in a water column having a fiber optic core, an electrically conducting polymer jacket, and a temperature sensor embedded in the polymer jacket.

U.S. Pat. No. 6,236,789 details a composite cable for access networks having one or more buffer tubes, each buffer tube encircling at least two optical fibers for supplying optical signals to at least two of the units, each unit having electrical current and voltage requirements. The cable has a layer of S-Z stranded electrically insulated conductors around the buffer tube or tubes. The number of pairs of conductors is less than the number of active optical fibers which excludes conductor spares. Preferably, the buffer tubes are S-Z stranded. The cable also includes a strength member and an outer plastic jacket encircling the buffer tubes, the conductors and the strength member.

It is also known that dynamic temperature systems have been placed in a cable crossing the Gulf of Aqaba in 1997 and a in cable placed in between Norway and Denmark in 1995.

The Gulf of Aqaba system used a submarine power cable with a fiber optic cable temperature sensing element, which was attached to the surface of four power cables at both land sections. The fiber optic cable continuously measuring the surface temperature profile of the power cables along the entire land cable routes from the cable terminations to 5 m beyond the low water mark. This arrangement is not desirable because a fiber optic temperature system attached to the surface of the cable would not provide accurate information regarding the temperature of the cable.

In the case of the system in between Denmark and Norway, the temperature sensor was installed at the land section in Denmark. The fiber optic cable applied as the temperature sensor is not longitudinally fixed to the power cable, but crosses the cable transversally at five points and in addition crossing two other cables at four points. The armor temperatures of the power cables are only measured at these points and would not provide information for the length of the cable.

### SUMMARY OF THE INVENTION

The present invention alleviates the failings of the prior art by using a fiber optic transmission conductor (FOTC), which is able to carry large amounts of electrical power, provide the medium for self-monitoring, and transport high-speed data for communication purposes. FOTC allows accurate real time temperature measurement along the entire length of the conductor because an optic fiber for temperature sensing is longitudinally placed inside the cable.

With FOTC, electrical utilities can maximize power flow through transmission conductors by using distributed temperature sensor (DTS) technology to accurately measure the temperature along the entire length of the FOTC conductor. A DTS monitor is connected to at least one optic fiber embedded in the transmission conductor. The DTS is able to accurately measure the temperature of the optic fiber inside the transmission conductor cable. The temperatures measured by the DTS directly relate to the temperature of the transmission conductor.

The FOTC could be used to perform a thermal acceptance test for conductor cables to verify that the size of the cable is acceptable for the amount of electricity traveling through the wire. A cable can be sized based on information supplied by a utility, and the cable can be monitored to ensure that cable sizing is adequate for the electrical load.

Furthermore, a cable, such as a 138-kV XLPE-insulated cable, with a temperature sensing optic fiber could be placed into a critical circuit. Because of the unknown thermal conditions surrounding the critical circuit, the temperature sensing optic fiber could be used to determine accurate ratings needed for new cables. Such a method could be used to monitor and rate critical circuits.

### BRIEF DESCRIPTION OF THE DRAWINGS

The present invention will be further understood with reference to the drawings, wherein:

FIG. 1 is an electrical conductor cable in accordance with the present invention,

FIG. 2 an embodiment of the present invention,

FIG. 3 is another view of an embodiment of the present invention, and

FIG. 4 is a block diagram of a system using an electrical conductor cable in accordance with the present invention.

### DETAILED DESCRIPTION OF THE INVENTION

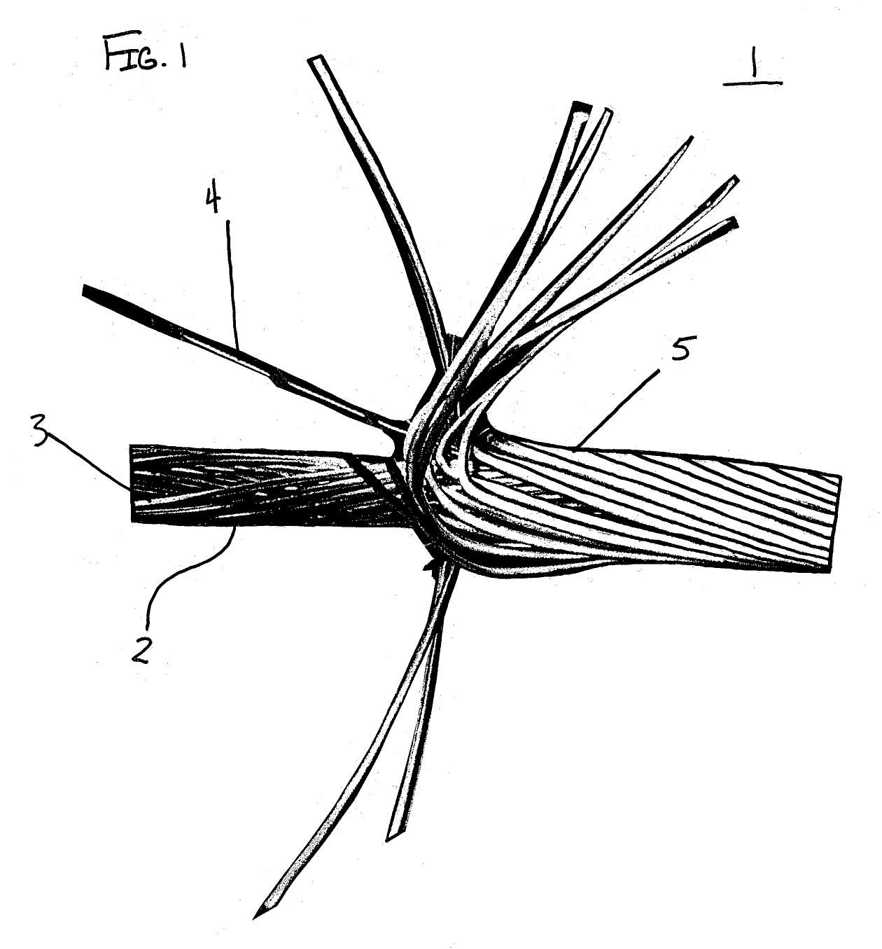

FIG. 1 depicts an electrical conductor cable called a fiber optic transmission conductor (1) in accordance with the present invention. The fiber optic transmission conductor has a conductive core (2) comprised of strands (3). At least one optic fiber (4) is placed near the conductive core (2). The optic fiber (4) is preferably heat resistant due to being composed of heat resistant materials, such as quartz, or due to it being coated with a heat resistant material, such as a polymide coating. A polymide coating would allow an optic fiber to be operable at temperatures up to 300° C. The conductive core (2) and the optic fiber (4) are surrounded by additional strands (5).

The optic fiber (4) can be placed in the conductive core (2). Furthermore, it is possible to have the optic fiber (4) replace one of the strands (3) of the conductive core (2) or replace one of the additional strands (5). It is also possible to have the optic fiber (4) be placed in an interstice formed by the strands (3), the additional strands (5), or the strands (3) and the additional strands (5). It is preferable to have the optic fiber (4) located near or in the conductive core (2) because this is where heat is generated due to electrical resistance. The optic fiber (4) can form an attachment with a measuring means, for example a computer or a different apparatus that could be used in a distributed temperature sensing system so the temperature can be measured along the entire length of the cable. A modified handler apparatus could be used to form the attachment where the cable terminates.

The optic fiber (4) can be used to transmit data in addition to measuring temperature. It is also possible to have more than one optic fiber (4) placed in the conductive cable (1), each having similar or different purposes (e.g., temperature measurement, or temperature measurement and data transfer).

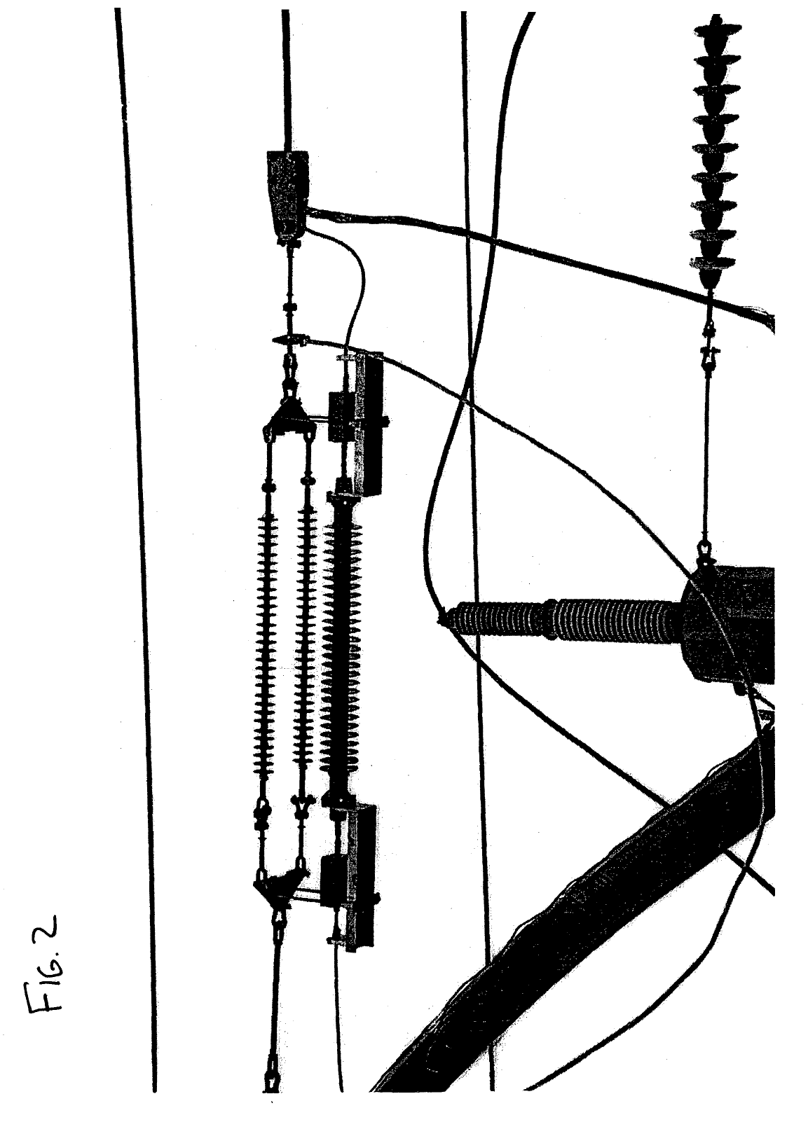

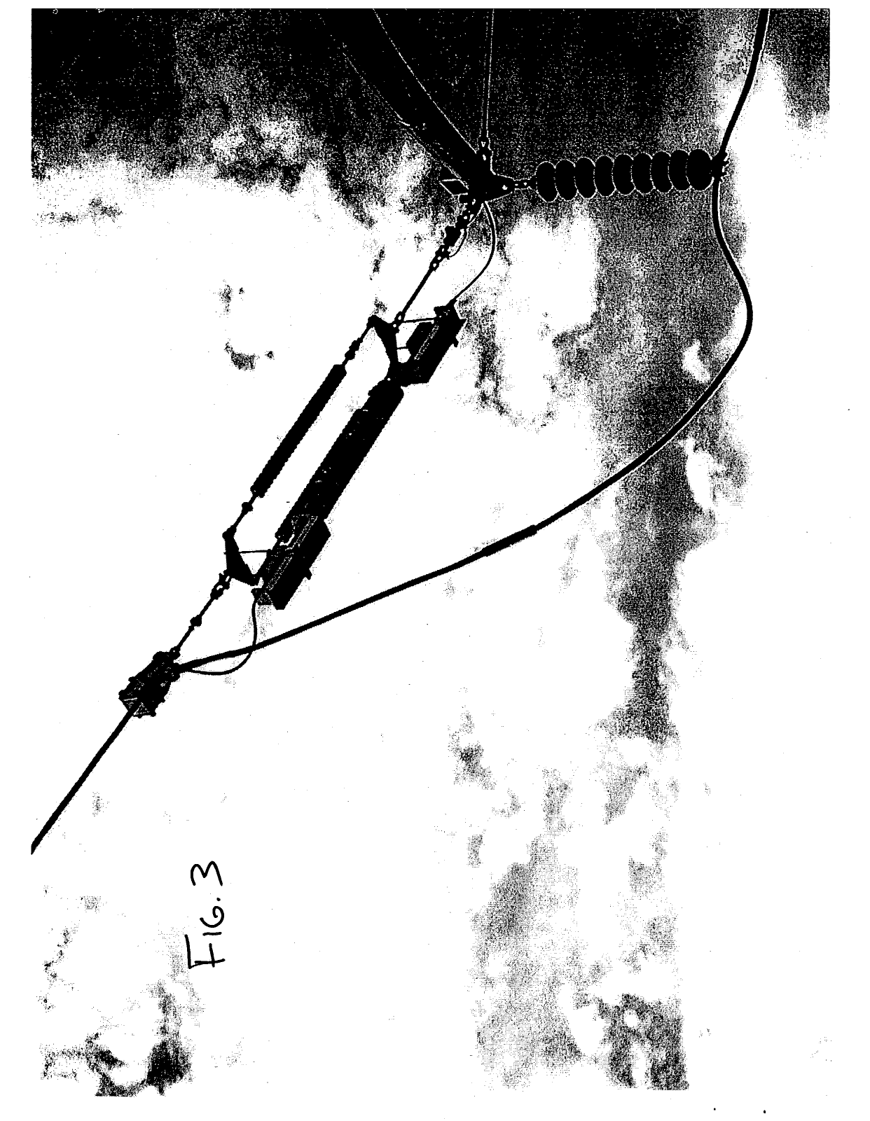

As shown in FIGS. 2 and 3, the fiber optic transmission conductor can be used in place of a conventional ACSR conductor.

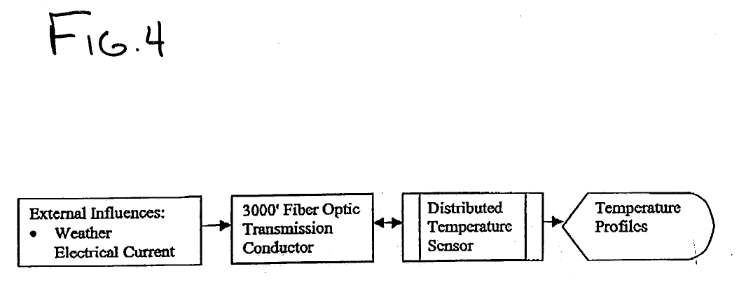

FIG. 4 depicts a block diagram for a system using the fiber optic transmission conductor. External influences such as weather and electrical current have an influence on the temperature of the fiber optic transmission conductor. A distributed temperature sensor can be used to generate temperature profiles for the system using a computer or the like to measure the temperature of the optic fiber, which correlates to the temperature of the fiber optic transmission conductor.

Furthermore, the fiber optic transmission conductor could be used to perform a thermal acceptance test for conductive cables to verify that the size of the cable is acceptable for the amount of electricity traveling through the cable. A fiber optic transmission conductor cable can be sized based on information supplied by a utility, and the cable can be attached to an electrical system and monitored, for example measuring the temperature of the optic fiber, to ensure that the cable sizing is adequate based on the electrical load and other external influences like temperature.

A fiber optic transmission conductor, such as a 138-kV XLPE-insulated cable with a temperature sensing optic fiber placed longitudinally along the cable, could be placed into a critical circuit, such as in a duct or an overhead transmission line, having unknown thermal conditions. The temperature sensing optic fiber could be used to determine ratings for new cables that would be used in the critical. Such a method allows the monitoring and rating of circuits.

Further variations and modifications of the foregoing will be apparent to those skilled in the art and are intended to be encompassed by the claims appended hereto.

What is claimed is:

1. A cable comprising:
a conductive core; and
an optic fiber located longitudinally inside the cable;
wherein the optic fiber can form an attachment with a measuring means.

2. The cable of claim 1,
wherein the optic fiber is located in an interstice of the cable.

3. The cable of claim 1,
wherein the optic fiber replaces a part of the conductive core.

4. The cable of claim 1,
wherein the optic fiber is placed on the conductive core.

5. A cable system comprising:
the cable of claim 1; and
a means for measuring the temperature of the optic fiber.

6. A method for determining a thermal acceptance of a conductive cable, comprising:
making a cable having an optic fiber longitudinally arranged inside the cable;
attaching the cable to an electrical system;
measuring the temperature of the optic fiber.

7. A method to rate a circuit, comprising:
placing the cable of claim 1 into the circuit;
determining a rating for a new conductive cable.

8. The method according to claim 7, wherein the circuit located in a duct.

9. The method according to claim 7, wherein the circuit is an overhead transmission cable.
